(19) United States
(12) Patent Application Publication
(10) Pub. No.: US 2025/0220480 A1
(43) Pub. Date: Jul. 3, 2025

(54) COMMUNICATION DEVICE AND METHOD FOR DETERMINING CHANNEL STATE INFORMATION REPORT BASED ON ARTIFICIAL INTELLIGENCE/MACHINE LEARNING

(71) Applicant: SHENZHEN TCL NEW TECHNOLOGY CO., LTD., Shenzhen, Guangdong (CN)

(72) Inventor: Yincheng ZHANG, Shenzhen, Guangdong (CN)

(73) Assignee: SHENZHEN TCL NEW TECHNOLOGY CO., LTD., Shenzhen, Guangdong (CN)

(21) Appl. No.: 18/852,428

(22) PCT Filed: Jun. 30, 2022
(86) PCT No.: PCT/CN2022/102917

§ 371 Date: Sep. 27, 2024

(51) Int. Cl. H04W 24/10; H04W 72/563

(52) U.S. Cl. CPC H04W 24/10; H04W 72/563

(57) ABSTRACT

Communication devices and methods for determining channel state information (CSI) report based on artificial intelligence (AI)/machine learning (ML) are provided. The method for determining CSI report based on AI/MI performed by a communication device includes determining, by the communication device, one or more CSI reports according to an AI/ML based CSI feedback, wherein each of the one or more CSI reports contains an output of an auto-encoder, a compression ratio, a rank indicator, quantization levels, a ground truth of an enhanced CSI feedback, and/or an ML model monitoring outcome, and determining, by the communication device, priority rules for the CSI reports according to the AI/ML based CSI feedback.

### BACKGROUND OF DISCLOSURE

### 1. Field of the Disclosure

The present disclosure relates to the field of wireless communication systems, and more particularly, to communication devices and methods for determining channel state information (CSI) report based on artificial intelligence (AI)/machine learning (ML), for example, the present disclosure is related to the new study item description (SID) on AI/ML for new radio (NR) air interface of the Release 18, which is established in 3rd generation partnership project (3GPP) radio access network (RAN) plenary meetings 94e in December 2022. Particularly, the present disclosure is related to the determining of priority rules for CSI reports.

### 2. Description of the Related Art

The AI/ML is applied to the 3GPP RAN1. Several use cases are decided to be studied. They are respectively a CSI feedback enhancement, a beam management, and a positioning. As indicated in the 3GPP new SID, although specific AI/ML algorithms and models may be studied for evaluation purposes, AI/ML algorithms and models are implementation specific and are not expected to be specified.

Therefore, there is a need for communication devices and methods for determining channel state information (CSI) report based on artificial intelligence (AI)/machine learning (ML), which can solve the issues in the prior art, clarify a new CSI report which contains a compressed CSI output based on an AI/ML model, solve the problem when multiple (new) CSI reports overlap in PUSCH or PUCCH, solve the problem when data from data collection and/or model monitoring information overlaps with the (new) CSI reports, reduce system overhead, provide a good communication performance, and/or provide high reliability.

### SUMMARY

An object of the present disclosure is to propose communication devices and methods for determining channel state information (CSI) report based on artificial intelligence (AI)/machine learning (ML), which can solve the issues in the prior art, provide the assistant information for AI/ML model to work properly, reduce system overhead, provide a good communication

In a first aspect of the present disclosure, a method for determining channel state information (CSI) report based on artificial intelligence (AI)/machine learning (ML) performed by a communication device includes determining, by the communication device, one or more CSI reports according to an AI/ML based CSI feedback, wherein each of the one or more CSI reports contains an output of an auto-encoder, a compression ratio, a rank indicator, quantization levels, a ground truth of an enhanced CSI feedback, and/or an ML model monitoring outcome, and determining, by the communication device, priority rules for the CSI reports according to the AI/ML based CSI feedback.

In a second aspect of the present disclosure, a user equipment (UE) comprises a memory, a transceiver, and a processor coupled to the memory and the transceiver. The processor is configured to execute the above method.

In a third aspect of the present disclosure, a base station comprises a memory, a transceiver, and a processor coupled to the memory and the transceiver. The processor is configured to execute the above method.

In a fourth aspect of the present disclosure, a non-transitory machine-readable storage medium has stored thereon instructions that, when executed by a computer, cause the computer to perform the above method.

In a fifth aspect of the present disclosure, a chip includes a processor, configured to call and run a computer program stored in a memory, to cause a device in which the chip is installed to execute the above method.

In a sixth aspect of the present disclosure, a computer readable storage medium, in which a computer program is stored, causes a computer to execute the above method.

In a seventh aspect of the present disclosure, a computer program product includes a computer program, and the computer program causes a computer to execute the above method.

In an eighth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of a basic auto-encoder model for enhanced CSI feedback according to an embodiment of the present disclosure.

FIG. 2 is a block diagram of one or more user equipments (UEs) and a base station (e.g., gNB) of communication in a communication network system according to an embodiment of the present disclosure.

FIG. 3 is a flowchart illustrating a wireless communication for determining channel state information (CSI) report related to artificial intelligence (AI)/machine learning (ML) performed by a UE according to an embodiment of the present disclosure.

FIG. 4 is a flowchart illustrating a wireless communication for determining channel state information (CSI) report related to artificial intelligence (AI)/machine learning (ML) performed by a first base station according to an embodiment of the present disclosure.

FIG. 5 is a schematic diagram illustrating an example of a basic auto-encoder model for enhanced CSI feedback according to an embodiment of the present disclosure.

FIG. 6 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Terminologies is used for discussion of channel state information (CSI) report based on artificial intelligence (AI)/machine learning (ML). The description of the terminologies is illustrated in Table 1.

TABLE 1

| Terminology | Description |
|---|---|
| Data collection | A process of collecting data by the network |
| | nodes, management entity, or UE for the |
| | purpose of AI/ML model training, data |
| | analytics and inference |
| AI/ML Model | A data driven algorithm that applies AI/ML |
| | techniques to generate a set of outputs |
| | based on a set of inputs. |
| AI/ML model training | A process to train an AI/ML Model [by |
| | learning the input/output relationship] |
| | in a data driven manner and obtain the |
| | trained AI/ML Model for inference |
| AI/ML model Inference | A process of using a trained AI/ML model |
| | to produce a set of outputs based on a set |
| | of inputs |
| AI/ML model validation | A subprocess of training, to evaluate the |
| | quality of an AI/ML model using a dataset |
| | different from one used for model training, |
| | that helps selecting model parameters that |
| | generalize beyond the dataset used for model |
| | training. |
| AI/ML model testing | A subprocess of training, to evaluate the |
| | performance of a final AI/ML model using |
| | a dataset different from one used for |
| | model training and validation. Differently |
| | from AI/ML model validation, testing does |
| | not assume subsequent tuning of the model. |
| UE-side (AI/ML) model | An AI/ML Model whose inference is |
| | performed entirely at the UE |
| Network-side (AI/ML) | An AI/ML Model whose inference is |
| model | performed entirely at the network |
| One-sided (AI/ML) | A UE-side (AI/ML) model or a Network-side |
| model | (AI/ML) model |
| Two-sided (AI/ML) | A paired AI/ML Model(s) over which joint |
| model | inference is performed, where joint |
| | inference comprises AI/ML Inference whose |
| | inference is performed jointly across the |
| | UE and the network, i.e., the first part |
| | of inference is firstly performed by UE |
| | and then the remaining part is performed |
| | by gNB, or vice versa. |
| AI/ML model transfer | Delivery of an AI/ML model over the air |
| | interface, either parameters of a model |
| | structure known at the receiving end or |
| | a new model with parameters. Delivery may |
| | contain a full model or a partial model. |
| Model download | Model transfer from the network to UE |
| Model upload | Model transfer from UE to the network |
| Federated learning/ | A machine learning technique that trains an |
| federated training | AI/ML model across multiple decentralized |
| | edge nodes (e.g., UEs, gNBs) each performing |
| | local model training using local data samples. |
| | The technique requires multiple interactions |
| | of the model, but no exchange of local data |
| | samples. |
| Offline field data | The data collected from field and used for |
| | offline training of the AI/ML model |
| Online field data | The data collected from field and used for |
| | online training of the AI/ML model |
| Model monitoring | A procedure that monitors the inference |
| | performance of the AI/ML model |
| Supervised learning | A process of training a model from input and |
| | its corresponding labels. |
| Unsupervised learning | A process of training a model without labelled |
| | data. |
| Semi-supervised | A process of training a model with a mix of |
| learning | labelled data and unlabelled data |
| Reinforcement | A process of training an AI/ML model from |
| Learning (RL) | input (a.k.a. state) and a feedback signal |
| | (a.k.a. reward) resulting from the model's |
| | output (a.k.a. action) in an environment the |
| | model is interacting with. |
| Model activation | enable an AI/ML model for a specific function |
| Model deactivation | disable an AI/ML model for a specific function |
| Model switching | Deactivating a currently active AI/ML model |
| | and activating a different AI/ML model for a |
| | specific function |

The AI/ML is applied to the 3GPP RAN1. Several use cases are decided to be studied. They are respectively a CSI feedback enhancement, a beam management, and a positioning. In current arts, some discussions are as follows. Spatial-frequency domain CSI compression using two-sided AI model is selected as one representative sub use case. Study of other sub use cases is not precluded. All pre-processing/post-processing, quantization/de-quantization are within the scope of the sub use case. Discussion conclusion includes: 1. Further discuss temporal-spatial-frequency domain CSI compression using two-sided model as a possible sub-use case for CSI feedback enhancement after evaluation methodology discussion. 2. Further discuss improving the CSI accuracy based on traditional codebook design using one-sided model as a possible sub-use case for CSI feedback enhancement after evaluation methodology discussion. 3. Further discuss CSI prediction using one-sided model as a possible sub-use case for CSI feedback enhancement after evaluation methodology discussion. 4. Further discuss CSI-RS configuration and overhead reduction as a possible sub-use case for CSI feedback enhancement after evaluation methodology discussion. 5. Further discuss resource allocation and scheduling as a possible sub-use case for CSI feedback enhancement after evaluation methodology discussion. 6. Further discuss joint CSI prediction and compression as a possible sub-use case for CSI feedback enhancement after evaluation methodology discussion.

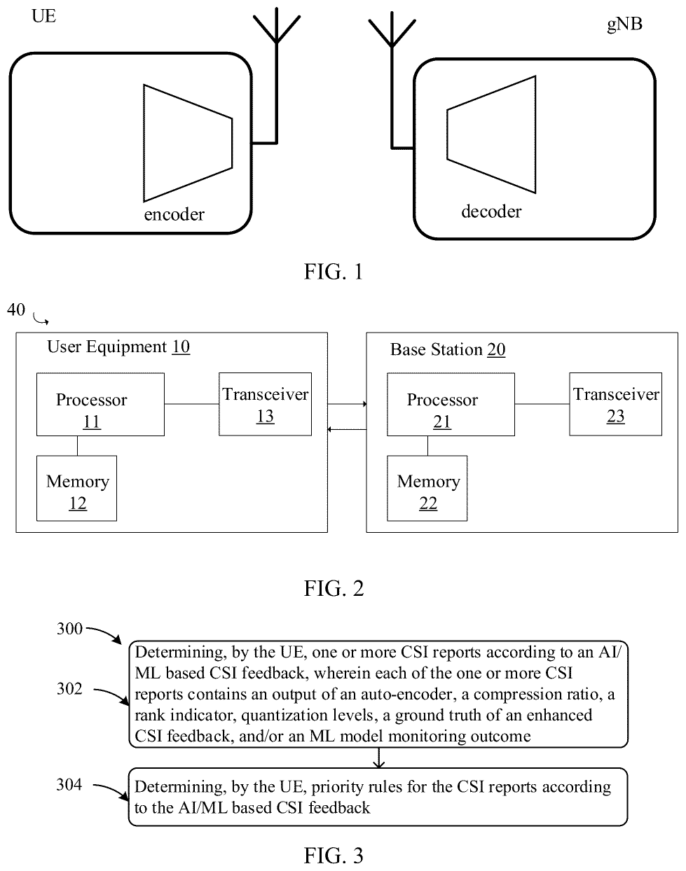

Some embodiments of the present disclosure discuss the CSI feedback enhancement case. FIG. 1 is a schematic diagram illustrating an example of a basic autoencoder model for enhanced CSI feedback according to an embodiment of the present disclosure. FIG. 1 illustrates that, in some embodiments, a basic model of auto-encoder is shown as follows. The encoder compressed the raw CSI-RS values (in short, raw CSI)/maximum Eigen vector and reports its output to the gNB. The gNB will decompress it. A new CSI report is the CSI report that contains the enhanced CSI feedback by an AI/ML model.

FIG. 2 illustrates that, in some embodiments, one or more user equipments (UEs) 10 and a base station (e.g., gNB) 20 for communication in a communication network system 40 according to an embodiment of the present disclosure are provided. The communication network system 40 includes the one or more UEs 10 and the base station 20 (such as a first base station or a second base station). The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, a method for determining channel state information (CSI) report based on artificial intelligence (AI)/machine learning (ML) performed by a communication device includes determining, by the communication device, one or more CSI reports according to an AI/ML based CSI feedback, wherein each of the one or more CSI reports contains an output of an auto-encoder, a compression ratio, a rank indicator, quantization levels, a ground truth of an enhanced CSI feedback, and/or an ML model monitoring outcome, and determining, by the communication device, priority rules for the CSI reports according to the AI/ML based CSI feedback. The communication device may be the UE 10 or the base station 20.

In some embodiments, the processor 11 is configured to determine one or more CSI reports according to an AI/ML based CSI feedback, wherein each of the one or more CSI reports contains an output of an auto-encoder, a compression ratio, a rank indicator, quantization levels, a ground truth of an enhanced CSI feedback, and/or an ML model monitoring outcome, and the processor 11 is configured to determine priority rules for the CSI reports according to the AI/ML based CSI feedback. This can solve the issues in the prior art, clarify a new CSI report which contains a compressed CSI output based on an AI/ML model, solve the problem when multiple (new) CSI reports overlap in PUSCH or PUCCH, solve the problem when data from data collection and/or model monitoring information overlaps with the (new) CSI reports, reduce system overhead, provide a good communication performance, and/or provide high reliability.

In some embodiments, the processor 21 is configured to determine one or more CSI reports according to an AI/ML based CSI feedback, wherein each of the one or more CSI reports contains an output of an auto-encoder, a compression ratio, a rank indicator, quantization levels, a ground truth of an enhanced CSI feedback, and/or an ML model monitoring outcome, and the processor 21 is configured to determine priority rules for the CSI reports according to the AI/ML based CSI feedback. This can solve the issues in the prior art, clarify a new CSI report which contains a compressed CSI output based on an AI/ML model, solve the problem when multiple (new) CSI reports overlap in PUSCH or PUCCH, solve the problem when data from data collection and/or model monitoring information overlaps with the (new) CSI reports, reduce system overhead, provide a good communication performance, and/or provide high reliability.

FIG. 3 illustrates a wireless communication method 300 for determining channel state information (CSI) report related to artificial intelligence (AI)/machine learning (ML) performed by a UE according to an embodiment of the present disclosure. In some embodiments, the method 300 includes: a block 302, determining, by the UE, one or more CSI reports according to an AI/ML based CSI feedback, wherein each of the one or more CSI reports contains an output of an auto-encoder, a compression ratio, a rank indicator, quantization levels, a ground truth of an enhanced CSI feedback, and/or an ML model monitoring outcome, and a block 304, determining, by the UE, priority rules for the CSI reports according to the AI/ML based CSI feedback. This can solve the issues in the prior art, clarify a new CSI report which contains a compressed CSI output based on an AI/ML model, solve the problem when multiple (new) CSI reports overlap in PUSCH or PUCCH, solve the problem when data from data collection and/or model monitoring information overlaps with the (new) CSI reports, reduce system overhead, provide a good communication

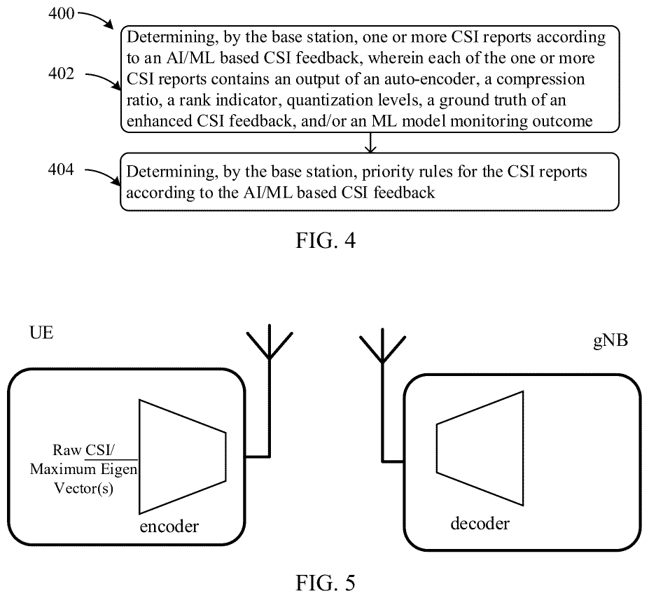

FIG. 4 illustrates a wireless communication method 400 for determining channel state information (CSI) report related to artificial intelligence (AI)/machine learning (ML) performed by a base station includes according to an embodiment of the present disclosure. In some embodiments, the method 400 includes: a block 402, determining, by the base station, one or more CSI reports according to an AI/ML based CSI feedback, wherein each of the one or more CSI reports contains an output of an auto-encoder, a compression ratio, a rank indicator, quantization levels, a ground truth of an enhanced CSI feedback, and/or an ML model monitoring outcome, and a block 404, determining, by the base station, priority rules for the CSI reports according to the AI/ML based CSI feedback. This can solve the issues in the prior art, clarify a new CSI report which contains a compressed CSI output based on an AI/ML model, solve the problem when multiple (new) CSI reports overlap in PUSCH or PUCCH, solve the problem when data from data collection and/or model monitoring information overlaps with the (new) CSI reports, reduce system overhead, provide a good communication performance, and/or provide high reliability.

In some embodiments, each of the one or more CSI reports comprises a single CSI report or a part 1 CSI report and a part 2 CSI report, a configurable CSI report, and/or an unbalanced CSI report. In some embodiments, when each of the one or more CSI reports comprises the single CSI report or the part 1 CSI report, the output of the auto-encoder and/or an output of an AI/ML model is contained in the single CSI report or the part 1 CSI report. In some embodiments, when each of the one or more CSI report parts comprises the part 2 CSI report, an output of a compressed CSI from an AI/ML model is contained in the part 2 CSI report. In some embodiments, when each of the one or more CSI reports comprises the configurable CSI report, whether the configurable CSI report comprises the single CSI report or the part 1 CSI report and the part 2 CSI report, and the configurable CSI report is determined by a base station or a CSI size of each of the one or more CSI reports. In some embodiments, when each of the one or more CSI reports comprises the unbalanced CSI report, if the unbalanced CSI report comprises the part 2 CSI report, the part 2 CSI report is configured not to be reported to a base station. In some embodiments, when each of the one or more CSI report parts comprises the unbalanced CSI report comprising the single CSI report or the part 1 CSI report and the part 2 CSI report, the single CSI report or the part 1 CSI report and the part 2 CSI report are individually configurable whether to be reported.

In some embodiments, the priority rules for the CSI reports according to the AI/ML based CSI feedback are associated with aperiodic CSI reports to be carried on a physical uplink shared channel (PUSCH), semi-persistent CSI reports to be carried on the PUSCH, semi-persistent CSI reports to be carried on a physical uplink control channel (PUCCH), and/or periodic CSI reports to be carried on the PUCCH. In some embodiments, the priority rules for the CSI reports refer to a priority value Pri_{iCSI}(y, k, c, s)=2·N_{cells}·Mₛ·y+N_{cells}·Mₛ·k+Mₛ·c+s, where: y=0 for the aperiodic CSI reports to be carried on the PUSCH, y=1 for the semi-persistent CSI reports to be carried on the PUSCH, y=2 for the semi-persistent CSI reports to be carried on the PUCCH, and y=3 for the periodic CSI reports to be carried on the PUCCH; k=0 for the CSI reports carrying a layer 1 reference signal received power (L1-RSRP) or a layer 1 signal-to-noise and interference ratio (L1-SINR) and k=1 for the CSI reports not carrying the L1-RSRP or the L1-SINR; c is a serving cell index and N_{cells} is a value of a higher layer parameter maxNrofServingCells; and s is reportConfigID and Mₛ is a value of a higher layer parameter maxNrofCSI-ReportConfigurations. In some embodiments, k is further associated with data collection and/or model monitoring. Further, in this technical solution, k=2 and/or k=3 are associated with data collection and/or model monitoring, and it will be described in detail in the following examples.

In some embodiments, the priority rules for the CSI reports refer to a priority value Pri_{iCSI}(y, k, c, s)=2·N_{cells}·Mₛ·y+N_{cells}·Mₛ·k+Mₛ·l+Mₛ·c+s or Pri_{iCSI}(y, k, c, s)=2·N_{cells}·Mₛ·y+N_{cells}·Mₛ·k+N_{cells}. Mₛ·l+Mₛ·c+s, where: y=0 for the aperiodic CSI reports to be carried on the PUSCH, y=1 for the semi-persistent CSI reports to be carried on the PUSCH, y=2 for the semi-persistent CSI reports to be carried on the PUCCH, and y=3 for the periodic CSI reports to be carried on the PUCCH; k=0 for the CSI reports carrying a layer 1 reference signal received power (L1-RSRP) or a layer 1 signal-to-noise and interference ratio (L1-SINR) and k=1 for the CSI reports not carrying the L1-RSRP or the L1-SINR; 1=0 for the CSI reports carrying or not carrying data collection (Data_Col) or model monitoring (Model_Monitor) for the AL/ML model; c is a serving cell index and N_{cells} is a value of a higher layer parameter maxNrofServingCells; and s is reportConfigID and Mₛ is a value of a higher layer parameter maxNrofCSI-ReportConfigurations.

FIG. 5 is a schematic diagram illustrating an example of a basic auto-encoder model for enhanced CSI feedback according to an embodiment of the present disclosure. FIG. 5 illustrates that some embodiments focus on one occasion of a CSI report. Particularly, it is about part 2 CSI for the new CSI report. Generally, there will be part 1 CSI. In some examples, there is part 2 CSI that will be provided by UE. In some other examples, there is no part 2 CSI from UE processing output.

FIG. 5 illustrates that, in some embodiments, there are two kinds designs for the auto-encoder model, according to the input. The input is the raw CSI (raw CSI-RS values). The input is the Eigen vector corresponding to the maximum Eigen value after channel matrix decomposition. Some embodiments term this Eigen vector as the maximum Eigen vector. Some examples may be added in the description for multiple CSIs sub use case with/without CSI prediction.

### EXAMPLES3

### Contained Part 2 CSI Report

In some examples, there is part 2 CSI for the new CSI report. The new CSI report contains the output of compress CSI from an AI/ML model. The makings of part 2 CSI will be explained as follows. In some examples, the input the AI/ML model (an encoder of the auto-encoder) at UE side, is the (maximum) Eigen vector(s). The output of the UE side AI/ML mode is the compressed the (maximum) Eigen vector(s). This output is a contained of the new CSI report. As an option, the part 2 CSI contains the compressed the (maximum) Eigen vector(s). The size of the compressed the (maximum) Eigen vector(s) is indicated by the RI (rank indictor) and/or quantization level and/or compression ratio which are contained in part 1 CSI. The part 1 CSI and the Part 2 CSI are separately encoded.

One example of the description is “For AI/ML enhanced CSI feedback, Part 1 contains RI, CQI, and/or an indication of compression ratio, and/or an indicator quantization levels, across layers for the AI/ML compressed CSI. The fields of Part 1—RI, CQI, and an indication of compression ratio, and/or quantization levels-are separately encoded. Part 2 contains the compressed Maximum Eigen Vector(s) of the AI/ML compressed CSI. Part 1 and 2 are separately encoded.” One example of the description is “For AI/ML enhanced CSI feedback, Part 1 contains RI, CQI, and/or an indication of an indicator quantization levels, across layers for the AI/ML compressed CSI. The fields of Part 1—RI, CQI, and an indication of compression ratio, and/or quantization levels—are separately encoded. Part 2 contains the compressed Maximum Eigen Vector(s) of the AI/ML assisted CSI and/or an indication of compression ratio. Part 1 and 2 are separately encoded.” The compression ratio is usually defined as the ratio of the input data size and output data size of the encoder in auto-encoder.

In some examples, the data collection (ground truth) report is involved in the new CSI report. In some examples, the “DataColCSI” {is a report type, like RI} denotes the data collection of ground truth of enhanced CSI feedback, in which the raw values of maximum Eigen vectors are reported. “Pre Vector” denotes the input of the AI/ML model/autoencoder model at UE side is the maximum Eigen vector(s). The “DataColCSI” and/or “PreVector” is a type of report, which is a RRC signaling. In some examples, “DataColCSI_PreVector” is one report type and RRC signaling, which indicates the report of both ground truth and the compressed the (maximum) Eigen vector(s). Please note that “DataColCSI”, “PreVector” and “DataColCSI_PreVector” does not necessarily have the same word by word.

If reportConfig is “DataColCSI_PreVector”, the CSI reports contains the raw values of maximum Eigen vectors and the compressed the (maximum) Eigen vector(s) from the output of AI/ML model at UE side. “DataColCSI_PreVector” indicates the report of both ground truth and the compressed the (maximum) Eigen vector(s). Both the raw values of maximum Eigen vectors and the compressed the (maximum) Eigen vector(s) are contained in the part 2 CSI. As an alternative, both the raw values of maximum Eigen vectors and the compressed the (maximum) Eigen vector(s) are contained in the part 1 CSI.

If reportConfig is “DataColCSI”, the raw values of maximum Eigen vector(s), which is the ground truth, are reported by UE to gNB. “DataColCSI” is just a notation, which does not have necessarily exact form. In some examples, the raw values of maximum Eigen vector(s) are contained in part 1 CSI. In some examples, the raw values of maximum Eigen vector(s) are contained in part 2 CSI. In some examples, the raw values of maximum Eigen vector(s) are contained in a MAC-CE. In some examples, the data collection is a mode. It can be activated or deactivated. The activation or deactivation is a RRC signaling/MAC-CE/DCI or preconfigured by RRC/MAC-CE and activated/deactivated by DCI. In some examples, if the data collection is activated, the raw values of maximum Eigen vector(s), which is the ground truth, is contained in part 1 CSI. In some examples, if the data collection is activated, the raw values of maximum Eigen vector(s), which is the ground truth, is contained in part 2 CSI. In some examples, if the data collection is activated, the raw values of maximum Eigen vector(s), which is the ground truth, is contained in a MAC-CE. In some examples, the RAW CSI is the input of an encoder of an auto-encoder/AI/ML model at the UE side. At the gNB side, the compressed CSIs are decompressed. In the following, this use case is termed as AI/ML enhanced CSI feedback. The output of a autoencoder/AI/ML model at the UE side is termed as AI/ML compressed CSI, if the input of a autoencoder/AI/ML model at the UE side is the RAW CSI.

The output of the encoder of an auto-encoder/an AI/ML model at the UE side. Since the raw CSI is compressed by AI/ML model, there is no RI (rank indicator). The quantization level can be an indication of the size of the compressed raw CSIs. In some examples, the quantization level is indicated by RRC signaling or DCI, which is not contained and implicitly indicated in the CSI report. One example can be described as “For AI/ML enhanced CSI feedback, Part 1 contains RI and/or CQI, and/or an indication of compression ratio, and/or quantization levels, across layers for the AI/ML compress CSI. The fields of Part 1—an indication of compression ratio, and/or quantization levels—are separately encoded. Part 2 contains the compressed raw CSI(s) of the AI/ML assisted CSI. Part 1 and 2 are separately encoded.”

One example can be described as “for AI/ML enhanced CSI feedback, Part 1 contains RI and/or CQI, and/or an indication of compression ratio, and/or quantization levels, across layers for the AI/ML compressed CSI. The fields of Part 1—RI, and/or CQI, and/or quantization levels—are separately encoded. Part 2 contains the compressed raw CSI(s) of the AI/ML assisted CSI and/or an indication of compression ratio,. Part 1 and 2 are separately encoded.”

One example can be described as “for AI/ML enhanced CSI feedback, Part 1 contains an indication of compression ratio, and/or quantization levels, across layers for the AI/ML compressed CSI. The fields of Part 1—an indication of compression ratio, and/or quantization levels—are separately encoded. Part 2 contains the compressed raw CSI(s) of the AI/ML assisted CSI. Part 1 and 2 are separately encoded.”

One example can be described as “For AI/ML enhanced CSI feedback, Part 1 contains an indication of compression ratio, and/or quantization levels, across layers for the AI/ML compressed CSI. The fields of Part 1—an indication of compression ratio, and/or quantization levels—are separately encoded. Part 2 contains the compressed raw CSI(s) of the AI/ML assisted CSI and/or an indication of compression ratio. Part 1 and 2 are separately encoded.”

In some examples, the data collection (ground truth) report is involved in the new CSI report. If reportConfig is “DataColCSI_PreVector”, the CSI report contains the compressed raw CSI and the data collection (ground truth) of the raw CSI. Please note the compressed raw CSI and the data collection (ground truth) of the raw CSI can be different raw CSIs. In some examples, both the raw values of ground truth CSI and the compressed raw CSIs are contained in the part 2 CSI. In some examples, both the raw values of ground truth CSI and the compressed raw CSIs are contained in the part 1 CSI. In some examples, the “DataColCSI_Pre Vector” indicates the report of both raw CSI ground truth and the compressed raw CSI.

If reportConfig is “DataColCSI”, the data collection (ground truth CSI) is reported. In some examples, the ground truth raw CSI is contained in part 1 CSI. In some examples, the ground truth raw CSI is contained in part 2 CSI. In some examples, the ground truth raw CSI is contained in MAC-CE. In some examples, the ground truth raw CSI is quantized before report, and de-quantized at the gNB side.

In some examples, the data collection is a mode. It can be activated or deactivated. The activation or deactivation is a RRC signaling/MAC-CE/DCI or preconfigured by RRC/MAC-CE and activated/deactivated by DCI. In some examples, if the data collection is activated, the ground truth raw CSI is contained in part 1 CSI. In some examples, if the data collection is activated, the ground truth raw CSI is contained in part 2 CSI. In some examples, if the data collection is activated, the ground truth raw CSI is contained in a MAC-CE. In some examples, the quantization level is an attribute or a hyper parameter of the ML model/autoencoder model. It can be implicitly known to UE and gNB at model deployment stage. In some examples, part 2 CSI contains the compressed raw CSIs or (maximum) Eigen vector(s) after quantization/. The compressed raw CSIs or (maximum) Eigen vector(s) is the output of the encoder AI/ML model at UE side.

### Contained in Single CSI Report or Part 1 CSI Report

In some examples, the ML model output at the UE-side of the auto-encoder is contained in the single CSI report or the part 1 CSI report. The making of part 1 CSI includes as follows. The input of the AI/ML model at UE side for enhanced CSI feedback is raw CSI. Or the input of a encoder of the autoencoder at the UE side is raw CSI. The raw CSI is compressed by AI/ML model and transmitted via air interface and decompressed at gNB side. The gNB can calculate the rank. Thus, there is no RI (rank indicator) in the CSI report. The quantization level of the encoder output at the UE side, is contained in the CSI report which is an indication of the size of the compressed raw CSIs. In some examples, the quantization level is an attribute or a hyper parameter of the ML model/autoencoder model. It can be implicitly known to UE and gNB at model deployment stage. In some examples, part 1 CSI contains the compressed raw CSIs after quantization. The compressed raw CSIs is the output of the encoder AI/ML model at UE side.

One example can be described as “for AI/ML assisted CSI feedback, Part 1 CSI contains RI and/or CQI, and/or an indication of compression ratio, and/or quantization levels, across layers for the AI/ML assisted CSI. The fields of Part 1—RI, and/or CQI, and/or an indication of compression ratio, and/or quantization levels and the compressed raw CSI(s)—are separately encoded.” One example can be described as “for AI/ML assisted CSI feedback, Part 1 CSI contains RI and/or CQI, and/or an indication of compression ratio, and/or quantization levels, across layers for the AI/ML assisted CSI. The fields of Part 1—RI, and/or CQI, and an indication of compression ratio, and/or quantization levels and the compressed raw CSI(s)—are jointly encoded.” The input of the AI/MI model at UE side is the maximum Eigen vector. Or the input of the auto-encoder at the UE side is the maximum Eigen vector. The maximum Eigen vector is compressed by AI/ML model and transmitted via air interface and decompressed at gNB side. The UE should calculate the RANK and report RI (rank indicator) in the CSI report. The quantization level is contained in the CSI report which is an indication of the size of the compressed raw CSIs.

In some examples, the quantization level is an attribute or a hyper parameter of an ML model/auto-encoder model. It can be implicitly known to UE and gNB at model deployment stage.

One example can be described as “for AI/ML assisted CSI feedback, Part 1 CSI contains RI and/or CQI, and/or an indication of compression ratio, and/or quantization levels, across layers for the AI/ML assisted CSI. The fields of Part 1—RI, and/or CQI, and/or an indication of compression ratio, and/or quantization levels and the compressed maximum Eigen vector—are separately encoded.” One example can be described as “for AI/ML assisted CSI feedback, Part 1 CSI contains RI and/or CQI, and/or an indication of compression ratio, and/or quantization levels, across layers for the AI/ML assisted CSI. The fields of Part 1—RI, and/or CQI, and an indication of compression ratio, and/or quantization levels and the compressed maximum Eigen vector—are jointly encoded.”

### Configurable CSI Report

When at least one of {the encoder output of an autoencoder, the ground truth data of data collection, the model monitoring data} is reported, whether the report of the CSI feedback consists of a single part, or a part 1 CSI and a part 2 CSI is determined by at least one of following methods. In some examples, if the CSI size is bigger than a threshold, the part 2 CSI comprises auto-encoder output from above examples. The threshold is a RRC signaling/MAC-CE/DCI. The threshold value can be configured by a gNB or reported by a UE. Otherwise, it is contained in part 1 CSI and the CSI consists of a single part. In some examples, whether the output of the encoder of the auto-encoder at UE side is contained in part 2 CSI or the report of the CSI feedback consists of a single part or a part 1 CSI and a part 2 CSI, is configured by gNB, via RRC signaling/DCI/MAC-CE.

As an example, the configuration is a signaling in higher layer parameter reportQuantity indicating the report for at least one of {the encoder output of an auto-encoder, the collected data from data collection for enhanced CSI feedback, such as raw CSI or (maximum) Eigen vectors, the model monitoring data of an auto-encoder model}, such that the CSI feedback consists of a single part.

As an example, the CSI is a single part is not limited to the enhancement CSI feedback by ML, the configuration is a signaling in higher layer parameter reportQuantity indicating the report for at least one of {the data of data collection for beam prediction in time domain or in spatial domain, the model monitoring data for beam prediction in time domain or in spatial domain, and the data of data collection for positioning, the model monitoring data for positioning}, such that the CSI feedback consists of a single part.

### Unbalanced CSI Report

In some examples, if there is part 2 CSI report, it is intentionally not reported to the gNB. The report of part 1 CSI and part 2 CSI is individually configurable. Since the part 1 CSI is less time dependent, it can be predicted or interpolated from historical part 1 CSIs by gNB. The part 2 CSI is reported in each configured report occasion. Part 1 CSI is reported in every a few report occasions. The related signaling here is the individual report of part 2 CSI, which can be a RRC signaling/DCI field or a MAC CE.

### Priority rules of CSI Reports

When the multiple CSI reports overlap, there should be rules to decide which CSI report should go first. CSI reports are associated with a priority value Pri_{iCSI}(y, k, c, s)=2·N_{cells}·Mₛ·y+N_{cells}·Mₛ·k+Mₛ·c+s where:

y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH; k=0 for CSI reports carrying L1-RSRP or L1-SINR or and k=1 for CSI reports not carrying L1-RSRP or L1-SINR; c is the serving cell index and N_{cells} is the value of the higher layer parameter maxNrofServingCells; s is the reportConfigID and Mₛ is the value of the higher layer parameter maxNrofCSI-ReportConfigurations. It can be understood that the parameter definitions such as y=0, y=1, y=2, y=3, k=0, k=1, c, N_{cells}·S, Mₛ here are the same as those of the previous embodiment.

### Embodiment 1: Mixed Indication

In some examples, the “Data_Col” indicated for data collection of an AI/ML model/use case. Further, “Model_Monitor” is indicated for model monitoring for an AI/ML model.

“CSI reports are associated with a priority value Pri_{iCSI}(y, k, c, s)=2·N_{cells}·Mₛ·y+N_{cells}·Mₛ·k+Mₛ·c+s where:

y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH; k=0 for CSI reports carrying L1-RSRP or L1-SINR and k=1 for CSI reports not carrying L1-RSRP or L1-SINR; c is the serving cell index and N_{cells} is the value of the higher layer parameter maxNrofServingCells; s is the reportConfigID and Mₛ is the value of the higher layer parameter maxNrofCSI-ReportConfigurations. It can be understood that the parameter definitions such as y=0, y=1, y=2, y=3, k=0, k=1, c, N_{cells}·S, Mₛ here are the same as those of the previous embodiment.

In some examples, k=2 for CSI reports carrying model monitoring information and k=3 for CSI reports carrying data from data collection. “k=0 for CSI reports carrying L1-RSRP or L1-SINR and not carriying Data_Col or Model_Monitor and k=1 for CSI reports not carrying L1-RSRP or L1-SINR or Data_Col or Model_Monitor, k=2 for CSI reports carrying for data collection information and k=3 for CSI reports carrying Model_Monitor”. The data collection information means the data collected and/or information need for data collection.

In some examples, k=2 for CSI reports carrying data collection information and k=3 for CSI reports carrying model monitoring information. “k=0 for CSI reports carrying L1-RSRP or L1-SINR and not carriying Data_Col or Model Monitor and k=1 for CSI reports not carrying L1-RSRP or L1-SINR or Data_Col or Model Monitor, k=2 for CSI reports carrying Model Monitor data collection and k=3 for CSI reports carrying Data_Col”.

In some examples, k=2, for CSI reports carrying information on data collection and/or model monitoring information. “k=0 for CSI reports carrying L1-RSRP or L1-SINR and not carriying Data_Col or Model_Monitor and k=1 for CSI reports not carrying L1-RSRP or L1-SINR or Data_Col or Model Monitor, k=2 for CSI reports carrying Model_Monitor data collection and/or CSI reports carrying Data_Col”.

In some examples, k=0, CSI reports carrying data collection information and/or model monitoring information. “k=0 for CSI reports carrying Data_Col or Model Monitor and k=1 for CSI reports carrying L1-RSRP or L1-SINR and not carrying Data_Col or Model_Monitor, k=2 for CSI reports not carrying carrying L1-RSRP or L1-SINR or Model Monitor data collection and/or Data_Col”.

In some examples, k=0, CSI reports carrying data collection information and k=1 for CSI reports carrying model monitoring information. “k=0 for CSI reports carrying Data_Col, and k=1 for CSI reports carrying Model_Monitor and k=1 for CSI reports carrying L1-RSRP or L1-SINR and not carrying Data_Col or Model Monitor, k=2 for CSI reports not carrying carrying L1-RSRP or L1-SINR or Model Monitor data collection and/or Data Col”.

In some examples, k=0 for CSI reports carrying model monitoring information and k=1 for CSI reports carrying data collection information. “k=0 for CSI reports carrying Model Monitor, and k=1 for CSI reports carrying Data_Col and k=1 for CSI reports carrying L1-RSRP or L1-SINR and not carrying Data_Col or Model_Monitor, k=2 for CSI reports not carrying carrying L1-RSRP or L1-SINR or Model Monitor data collection and/or Data_Col”.

### Embodiment 2: Individual Indication for ML

In some examples, the “Data_Col” indicated for data collection of an AI/ML model/use case. Further, “Model_Monitor” is indicated for model monitoring for an AI/ML model.

In some examples, the priority equation can be, one of the followings. CSI reports are associated with a priority value Pri_{iCSI}(y, k, c, s)=2·N_{cells}·Mₛ·y+N_{cells}·Mₛ·k+Mₛ·l+Mₛ·c+s, or CSI reports are associated with a priority value Pri_{iCSI}(y, k, c, s)=2·N_{cells}·Mₛ·y+N_{cells}·Mₛ·k+N_{cells}·Mₛ·l+Mₛ·c+s, where:

y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH; k=0 for CSI reports carrying L1-RSRP or L1-SINR and k=1 for CSI reports not carrying L1-RSRP or L1-SINR; c is the serving cell index and N_{cells} is the value of the higher layer parameter maxNrofServingCells; s is the reportConfigID and Mₛ is the value of the higher layer parameter maxNrofCSI-ReportConfigurations.

In some examples, 1=0 for if CSI reports not carrying Model_Monitor, or carrying Data_Col, otherwise, 1=1. In some examples, 1=1 for if CSI reports carrying Model_Monitor, or carrying Data_Col, otherwise, 1=0. In some examples, 1=0 for if CSI reports carrying Model_Monitor, and 1=1 if CSI reports carrying Data_Col, otherwise, 1=2. In some examples, 1=0 for if CSI reports carrying Model_Monitor, and 1=1 if CSI reports not carrying Model_Monitor and Data_Col, otherwise, 1=2 if CSI reports carrying Data_Col. In some examples, 1=0 for if CSI reports carrying Data_Col, and 1=1 if CSI reports carrying Model_Monitor otherwise, 1=2. In some examples, 1=0 for if CSI reports carrying Data_Col, and 1=1 if CSI reports carrying Model Monitor otherwise, 1=2.

### Embodiment 3: Improved Indication with Mode

In some examples, the “Data_Col” indicated for data collection of an AI/ML model/use case. Further, “Model_Monitor” is indicated for model monitoring for an AI/ML model.

“CSI reports are associated with a priority value Pri_{ICSL}(y, k, c, s)=2. N_{cells}·Mₛ·y+N_{cells}. Mₛ·k+Mₛ·c+s where:

y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH; k=0 for CSI reports carrying L1-RSRP or L1-SINR and k=1 for CSI reports not carrying L1-RSRP or L1-SINR; c is the serving cell index and N_{cells} is the value of the higher layer parameter maxNrofServingCells; s is the reportConfigID and Mₛ is the value of the higher layer parameter maxNrofCSI-ReportConfigurations.

Machine learning is usually with better performance the report related to ML is with high priority. The reporting that probability related to the “k”.

In some examples, if in model monitoring (mode) and/or data collection (mode), k=0 for CSI reports carrying the report related to model monitoring or data collection, and k=1 for CSI reports not carrying the information. The report related to model monitoring or data collection can be at least one of L1-RSRP, L1-SINR, raw-CSI/Maximum Eigen Vectors, Compressed CSI/Eigen vectored by an auto-encoder, positioning information. Otherwise, k=0 for CSI reports carrying L1-RSRP or L1-SINR and k=1 for CSI reports not carrying L1-RSRP or L1-SINR.

In some examples, if in model monitoring mode and/or data collection (mode), k=0 for CSI reports carrying the report related to data collection, and k=1 for CSI reports carrying the reports related model monitoring, and k=2 for CSI reports not carrying the information. The report related to model monitoring or data collection can be at least one of L1-RSRP, L1-SINR, RAW-CSI/Maximum Eigen Vectors, Compressed CSI/Eigen vectored by an auto-encoder, positioning information. Otherwise, k=0 for CSI reports carrying L1-RSRP or L1-SINR or and k=1 for CSI reports not carrying L1-RSRP or L1-SINR.

In some examples, if in model monitoring mode and/or data collection (mode) and/or at least one ML model is activated, k=0 for CSI reports carrying the report related to model monitoring, and k=1 for CSI reports carrying the reports related data collection, and k=2 for CSI reports not carrying the information. The report related to model monitoring or data collection can be at least one of L1-RSRP, L1-SINR, RAW-CSI/Maximum Eigen Vectors, Compressed CSI/Eigen vectored by an auto-encoder, positioning information. Otherwise, k=0 for CSI reports carrying L1-RSRP or L1-SINR or and k=1 for CSI reports not carrying L1-RSRP or L1-SINR.

In some examples, if in model monitoring mode and/or data collection (mode), and/or at least one ML model is activated. k=0 for CSI reports carrying the report related to data collection, and k=1 for CSI reports not carrying the information. The report related to model monitoring or data collection can be at least one of L1-RSRP, L1-SINR, RAW-CSI/Maximum Eigen Vectors, Compressed CSI/Eigen vectored by autoencoder, positioning information. and k=2 for CSI reports carrying the reports related model monitoring, Otherwise, k=0 for CSI reports carrying L1-RSRP or L1-SINR or and k=1 for CSI reports not carrying L1-RSRP or L1-SINR.

In some examples, if in model monitoring mode and/or data collection (mode) and/or at least one ML model is activated, k=0 for CSI reports carrying the report related to model monitoring, and k=1 for CSI reports not carrying the information. The report related to model monitoring or data collection can be at least one of L1-RSRP, L1-SINR, RAW-CSI/Maximum Eigen Vectors, compressed CSI/Eigen vectored by autoencoder, positioning information. and k=2 for CSI reports carrying the reports related data collection.

In another example, the machine learning model is with higher complexity and requires higher UE capability. The report related to machine learning is with lower priority. CSI reports are associated with a priority value Pri_{iCSI}(y, k, c, s)=2·N_{cells}·Mₛ·y+N_{cells}·Mₛ·k+Mₛ·l+Mₛ·c+s, or CSI reports are associated with a priority value Pri_{iCSI}(y, k, c, s)=2·N_{cells}·Mₛ·y+N_{cells}·Mₛ·k+N_{cells}·Mₛ·l+Mₛc+s, where

y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH; k=0 for CSI reports carrying L1-RSRP or L1-SINR and k=1 for CSI reports not carrying L1-RSRP or L1-SINR; c is the serving cell index and N_{cells} is the value of the higher layer parameter maxNrofServingCells; s is the reportConfigID and Mₛ is the value of the higher layer parameter maxNrofCSI-ReportConfigurations.

In some examples, if in model monitoring mode and/or data collection (mode), k=0 for CSI reports not carrying the information related to model monitoring and/or data collection, and k=1 for CSI reports carrying the information related to model monitoring or data collection. The report related to model monitoring or data collection can be at least one of L1-RSRP, L1-SINR, RAW-CSI/Maximum Eigen Vectors, Compressed CSI/Eigen vectored by auto-encoder, positioning information. Otherwise, k=0 for CSI reports carrying L1-RSRP or L1-SINR or and k=1 for CSI reports not carrying L1-RSRP or L1-SINR.

In some examples, if in model monitoring mode and/or data collection (mode) and/or at least one machine learning model is activated, k=0 for CSI reports not carrying the information related to model monitoring and/or data collection, and k=1 for CSI reports carrying the information related to model monitoring or data collection. The report related to model monitoring or data collection can be at least one of L1-RSRP, L1-SINR, RAW-CSI/Maximum Eigen Vectors, Compressed CSI/Eigen vectored by autoencoder, positioning information. Otherwise, k=0 for CSI reports carrying L1-RSRP or L1-SINR or and k=1 for CSI reports not carrying L1-RSRP or L1-SINR.

In some examples, if in model monitoring mode and/or data collection (mode) and/or at least one machine learning model is activated, k=0 for CSI reports not carrying the information related to model monitoring and/or data collection, and k=1 for CSI reports carrying the information related to model monitoring, and k=2 for CSI reports carrying the information related to model monitoring data collection. The report related to model monitoring or data collection can be at least one of L1-RSRP, L1-SINR, RAW-CSI/Maximum Eigen Vectors, Compressed CSI/Eigen vectored by autoencoder, positioning information. Otherwise, k=0 for CSI reports carrying L1-RSRP or L1-SINR or and k=1 for CSI reports not carrying L1-RSRP or L1-SINR.

In some examples, if in model monitoring mode and/or data collection (mode) and/or at least one machine learning model is activated, k=0 for CSI reports not carrying these information related to model monitoring and/or data collection, and k=1 for CSI reports carrying the information related to data collection, and k=2 for CSI reports carrying the information related to model monitoring model monitoring; The report related to model monitoring or data collection can be at least one of L1-RSRP, L1-SINR, RAW-CSI/Maximum Eigen Vectors, Compressed CSI/Eigen vectored by an auto-encoder, positioning information.

In summary, some embodiments of this disclosure are about determining the priority rules for CSI reports in the view of AI/ML based CSI feedback. At first, whether part 2 CSI is needed for the new CSI report is discussed. After that the new priority rule for the CSI reports is proposed. The new CSI feature which is the output of auto-encoder is accounted. Invention effects include at least one of the followings: 1. The new CSI report which contains the compressed output AI/ML is clarified, so as to know the particular report method of it. 2. When the overlapping occurs with the new CSI report of those from current CSI reports before Rel.18. (CSI of Rel. 17, CSI of Rel.

16, CSI of Rel. 15 . . . ), the priority rules to resolve it is provided. 3. The priority rule of aperiodic, semi-period and period CSIs with data collection and monitoring is provided. When those CSI reports overlaps, a CSI report is selected.

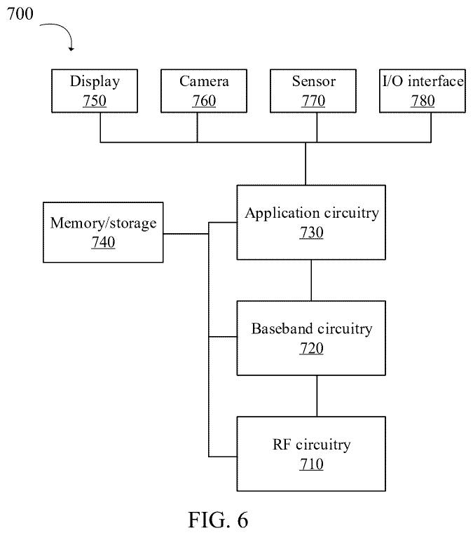

FIG. 6 is a block diagram of an example system 700 for wireless communication according to an embodiment of the present disclosure. Embodiments described herein may be implemented into the system using any suitably configured hardware and/or software. FIG. 6 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for determining channel state information (CSI) report based on artificial intelligence (AI)/machine learning (ML) performed by a communication device, comprising:
determining, by the communication device, one or more CSI reports according to an AI/ML based CSI feedback, wherein each of the one or more CSI reports contains at least one from an output of an auto-encoder, a compression ratio, a rank indicator, quantization levels, a ground truth of an enhanced CSI feedback, and/or an ML model monitoring outcome; and
determining, by the communication device, priority rules for the CSI reports according to the AI/ML based CSI feedback.

2. The method according to claim 1, wherein each of the one or more CSI reports comprises a single CSI report or a part 1 CSI report and a part 2 CSI report, a configurable CSI report, and/or an unbalanced CSI report.

3. The method according to claim 2, wherein when each of the one or more CSI reports comprises a single CSI report or the part 1 CSI report, the output of the auto-encoder and/or an output of an AI/ML model is contained in the single CSI report or the part 1 CSI report.

4. The method according to claim 2, wherein when each of the one or more CSI reports comprises the part 2 CSI report, an output of a compressed CSI from an AI/ML model is contained in the part 2 CSI report.

5. The method according to claim 2, wherein when each of the one or more CSI reports comprises the configurable CSI report, whether the configurable CSI report comprises the single CSI report or the part 1 CSI report and the part 2 CSI report, and the configurable CSI report is determined by a base station or a CSI size of each of the one or more CSI reports.

6. The method according to claim 2, wherein when each of the one or more CSI reports comprises the unbalanced CSI report, if the unbalanced CSI report comprises the part 2 CSI report, the part 2 CSI report is configured not to be reported to a base station.

7. The method according to claim 2, wherein when each of the one or more CSI reports comprises the unbalanced CSI report comprising the single CSI report or the part 1 CSI report and the part 2 CSI report, the single CSI report or the part 1 CSI report and the part 2 CSI report are individually configurable whether to be reported.

8. The method according to claim 1, wherein the priority rules for the CSI reports according to the AI/ML based CSI feedback are associated with aperiodic CSI reports to be carried on a physical uplink shared channel (PUSCH), semi-persistent CSI reports to be carried on the PUSCH, semi-persistent CSI reports to be carried on a physical uplink control channel (PUCCH), and/or periodic CSI reports to be carried on the PUCCH.

9. The method according to claim 8, wherein the priority rules for the CSI reports refer to a priority value Pri_{iCSI}(y, k, c, s)=2·N_{cells}·Mₛ·y+N_{cells}·Mₛ·k+Mₛ·c+s, where:
y=0 for the aperiodic CSI reports to be carried on the PUSCH, y=1 for the semi-persistent CSI reports to be carried on the PUSCH, y=2 for the semi-persistent CSI reports to be carried on the PUCCH, and y=3 for the periodic CSI reports to be carried on the PUCCH;
k=0 for the CSI reports carrying a layer 1 reference signal received power (L1-RSRP) or a layer 1 signal-to-noise and interference ratio (L1-SINR) and k=1 for the CSI reports not carrying the L1-RSRP or the L1-SINR;
c is a serving cell index and N_{cells} is a value of a higher layer parameter maxNrofServingCells; and
s is reportConfigID and Mₛ is a value of a higher layer parameter maxNrofCSI-ReportConfigurations.

10. The method according to claim 9, wherein k is further associated with data collection and/or model monitoring.

11. The method according to claim 8, wherein the priority rules for the CSI reports refer to a priority value Pri_{iCSI}(y, k, c, s)=2·N_{cells}·Mₛ·y+N_{cells}·Mₛ·k+Mₛ·l+Mₛ·c+s or Pri_{iCSI}(y, k, c, s)=2·N_{cells}·Mₛ·y+N_{cells}·Mₛ·k+N_{cells}·Mₛ·l+Mₛ ·c+s, where:
y=0 for the aperiodic CSI reports to be carried on the PUSCH, y=1 for the semi-persistent CSI reports to be carried on the PUSCH, y=2 for the semi-persistent CSI reports to be carried on the PUCCH, and y=3 for the periodic CSI reports to be carried on the PUCCH;
k=0 for the CSI reports carrying a layer 1 reference signal received power (L1-RSRP) or a layer 1 signal-to-noise and interference ratio (L1-SINR) and k=1 for the CSI reports not carrying the L1-RSRP or the L1-SINR;
l=0 for the CSI reports carrying or not carrying data collection (Data_Col) or model monitoring (Model_Monitor) for the AL/ML model;
c is a serving cell index and N_{cells} is a value of a higher layer parameter maxNrofServingCells; and
s is reportConfigID and Mₛ is a value of a higher layer parameter maxNrofCSI-ReportConfigurations.

12-18. (canceled)

19. A communication device, comprising:
a memory;
a transceiver; and
a processor coupled to the memory and the transceiver;
wherein the processor is configured to:
determine one or more channel state information (CSI) reports according to an artificial intelligence (AI)/machine learning (ML) based CSI feedback, wherein each of the one or more CSI reports contains at least one from an output of an auto-encoder, a compression ratio, a rank indicator, quantization levels, a ground truth of an enhanced CSI feedback, and/or an ML model monitoring outcome; and
determine priority rules for the CSI reports according to the AI/ML based CSI feedback.

20. The communication device according to claim 19, wherein each of the one or more CSI reports comprises a single CSI report or a part 1 CSI report and a part 2 CSI report, a configurable CSI report, and/or an unbalanced CSI report.

21. The communication device according to claim 20, wherein when each of the one or more CSI reports comprises a single CSI report or the part 1 CSI report, the output of the auto-encoder and/or an output of an AI/ML model is contained in the single CSI report or the part 1 CSI report.

22. The communication device according to claim 20, wherein when each of the one or more CSI reports comprises the part 2 CSI report, an output of a compressed CSI from an AI/ML model is contained in the part 2 CSI report.

23. The communication device according to claim 20, wherein when each of the one or more CSI reports comprises the configurable CSI report, whether the configurable CSI report comprises the single CSI report or the part 1 CSI report and the part 2 CSI report, and the configurable CSI report is determined by a base station or a CSI size of each of the one or more CSI reports.

24. The communication device according to claim 20, wherein when each of the one or more CSI reports comprises the unbalanced CSI report, if the unbalanced CSI report comprises the part 2 CSI report, the part 2 CSI report is configured not to be reported to a base station.

25. The communication device according to claim 20, wherein when each of the one or more CSI reports comprises the unbalanced CSI report comprising the single CSI report or the part 1 CSI report and the part 2 CSI report, the single CSI report or the part 1 CSI report and the part 2 CSI report are individually configurable whether to be reported.

26. The communication device according to claim 19, wherein the priority rules for the CSI reports according to the AI/ML based CSI feedback are associated with aperiodic CSI reports to be carried on a physical uplink shared channel (PUSCH), semi-persistent CSI reports to be carried on the PUSCH, semi-persistent CSI reports to be carried on a physical uplink control channel (PUCCH), and/or periodic CSI reports to be carried on the PUCCH.

27. The communication device according to claim 26, wherein the priority rules for the CSI reports refer to a priority value Pri_{iCSI}(y, k, c, s)=2·N_{cells}·Mₛ·y+N_{cells}·Mₛ·k+Mₛ·c+s, where:
y=0 for the aperiodic CSI reports to be carried on the PUSCH, y=1 for the semi-persistent CSI reports to be carried on the PUSCH, y=2 for the semi-persistent CSI reports to be carried on the PUCCH, and y=3 for the periodic CSI reports to be carried on the PUCCH;
k=0 for the CSI reports carrying a layer 1 reference signal received power (L1-RSRP) or a layer 1 signal-to-noise and interference ratio (L1-SINR) and k=1 for the CSI reports not carrying the L1-RSRP or the L1-SINR;
c is a serving cell index and N_{cells} is a value of a higher layer parameter maxNrofServingCells; and
s is reportConfigID and Mₛ is a value of a higher layer parameter maxNrofCSI-ReportConfigurations.
